(19) United States
(12) Patent Application Publication
(10) Pub. No.: US 2010/0295790 A1
(43) Pub. Date: Nov. 25, 2010

(54) APPARATUS AND METHOD FOR DISPLAY SWITCHING IN A PORTABLE TERMINAL

(75) Inventor: Yong-Ju Yu, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/783,773

(22) Filed: May 20, 2010

(30) Foreign Application Priority Data
May 22, 2009 (KR) 10-2009-0044894

(51) Int. Cl. G06F 3/02; G06F 3/01

(52) U.S. Cl. 345/168; 715/744

(57) ABSTRACT

An apparatus and method for accurately determining whether or not to perform display switching in a portable terminal. The apparatus includes a controller for sensing an input for display switching, giving weights to a plurality of elements for display switching, combining the elements given the weights, judging whether to display switch or not dependent on a user's probable intention, and processing to switch a display.

### CLAIM OF PRIORITY

This application claims the benefit of priority under 35 U.S.C. §119(a) from Korean patent application assigned Serial No. 10-2009-0044894 and filed in the Korean Intellectual Property Office on May 22, 2009 and, the entire disclosure of which is hereby incorporated by reference in its entirety.

### BACKGROUND OF THE INVENTION

1. Field of the Invention

The present invention relates to an apparatus and method for switching the display direction of a portable terminal from length direction to width direction or from the width direction to the length direction, according to need. More particularly, the present invention relates to an apparatus and method for judging whether an input for changing the display direction of a portable terminal is an input intended by a user or is unintended input.

2. Description of the Related Art

In recent years, portable terminals have become widely used and are now considered a necessity to modern life. Service providers and system manufacturers are competitively developing products (or services) for the differentiation from other enterprises.

For example, advancements in technology has the portable terminals evolving into multimedia equipment for phone books, games, short messages, electronic mail (e-mail) messages, morning wakeup calls, MPEG-1 Audio Layer 3 (MP3) players, schedule management functions, digital cameras, and wireless Internet services and provide a variety of services.

The portable terminals support only the display direction of a portrait mode standing in a length direction and thus, users can suffer much inconvenience when determining a display information. For example, in case that a user of the portable terminal intends to use a function of Electronic book (E-book) of the portable terminal, as a line break of the E-book much occurs in a portrait mode in which a display is placed in standard position, there is a problem that he/she should frequently carry out a key input for line break.

In order to address the above problem, recently, portable terminals supporting a function of rotating a display of the portable terminal according to user's input are being put on the market. Due to this, in case that a user of the portable terminal intends to use a function of E-book of the portable terminal, as a line break of the E-book much occurs in a portrait mode in which the display is placed in standard position, he/she uses a landscape mode rotating the display in width direction to prevent the frequent occurrence of line breaks when reading the E-book.

Typically, in order to change a display mode from the portrait mode to the landscape mode, the portable terminal senses a key input or terminal motion for display rotation to change into a corresponding display mode.

However, the above function has a problem in that the portable terminal can operate to change orientation of the display even in response to an abnormal motion not intended by a user.

For one example, a user can make use of the function by moving the portable terminal; however, there is a problem that there occurs an unintended motion change of the portable terminal within a user's bag or pocket, unnecessarily rotating a display of the portable terminal, which also wastes energy of the battery. In fact, with the portable terminal often being hooked to a waist clip there are often abnormal motions of the portable terminal. Thus, there is a need in the art for an apparatus and method for judging a normal or abnormal operation of a portable terminal.

### SUMMARY OF THE INVENTION

An exemplary aspect of the present invention is to provide an apparatus and method for increasing the accuracy of an input for switching the display direction of a portable terminal from lengthwise display direction to widthwise (landscape) direction or from the widthwise direction to the lengthwise direction according to need in the portable terminal.

Another exemplary aspect of the present invention is to provide an apparatus and method for, upon receiving an input for display switching intended by a user, switching the display in a portable terminal.

A further exemplary aspect of the present invention is to provide an apparatus and method for judging a user's intentional input according to a time sensing a key input or terminal motion in a portable terminal.

The above exemplary aspects are achieved by providing an apparatus and method for display switching in a portable terminal.

In accordance with an exemplary aspect of the present invention, an apparatus for display switching in a portable terminal which includes a controller for sensing an input for display switching, giving weights to a plurality of elements for display switching, combining the elements given the weights, judging display switching or not dependent on a user, and processing to switch a display.

In accordance with another exemplary aspect of the present invention, a method for display switching in a portable terminal preferably includes sensing an input for display switching, giving weights to a plurality of elements for display switching, combining the elements given the weights, judging display switching or not dependent on a user's intention, and controlling display switching.

Other exemplary aspects, advantages and salient features of the invention will become more apparent to those skilled in the art from the following detailed description, which, taken in conjunction with the annexed drawings, discloses exemplary embodiments of the present invention.

### BRIEF DESCRIPTION OF THE DRAWINGS

The above and other exemplary objects, features and advantages of the present invention will become more apparent from the following detailed description when taken in conjunction with the accompanying drawings in which:

FIG. 1 is a block diagram illustrating a construction of a portable terminal making display rotation possible according to the present invention;

FIG. 2 is a flowchart illustrating an exemplary operational process of display rotation of a portable terminal according to the present invention;

FIG. 3 is a flowchart illustrating an exemplary operational process of display rotation of a portable terminal according to an exemplary embodiment of the present invention;

FIG. 4 is a flowchart illustrating an exemplary operational process of display rotation of a portable terminal according to another exemplary embodiment of the present invention; and

FIG. 5 is a flowchart illustrating an exemplary operational process of display rotation of a portable terminal according to a further exemplary embodiment of the present invention.

### DETAILED DESCRIPTION

The following description, with reference to the accompanying drawings, is provided to assist a person of ordinary skill in the art with a comprehensive understanding of certain exemplary embodiments of the invention provided herein for illustrative purposes. The description includes various specific details to assist a person of ordinary skill the art with understanding the claimed invention, but these details are to be regarded as merely exemplary. Accordingly, those of ordinary skill in the art will recognize that various changes and modifications of the illustrative examples described herein can be made without departing from the spirit of the invention and the scope of the appended claims. Also, descriptions of well-known functions and constructions may be omitted for clarity and conciseness when their inclusion may obscure appreciation of the subject matter of the claimed invention by a person of ordinary skill in the art.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustrative purposes only and is not to be construed as limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

The following describes an apparatus and method for increasing the accuracy of an input for switching the display direction of a portable terminal to perform display switching intended by a user according to the present invention. An example of such an apparatus is first discussed herein followed by a discussion of an exemplary method according to the present invention.

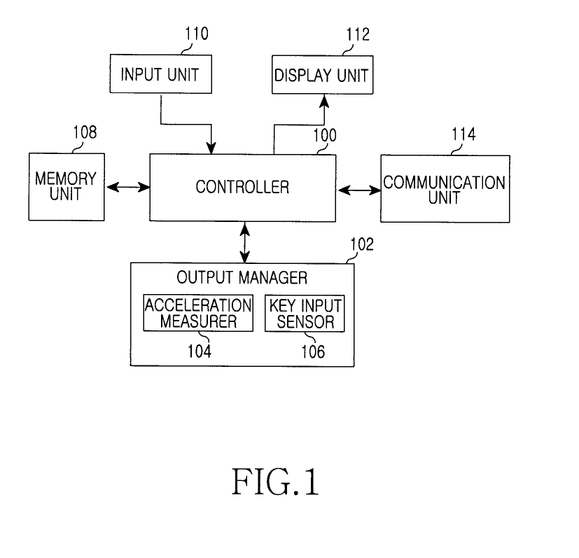

FIG. 1 is a block diagram illustrating a construction of a portable terminal making display rotation possible according to the present invention.

Referring now to FIG. 1, the portable terminal may include, for example, a controller 100, an output manager 102, a memory unit 108, an input unit 110, a display unit 112, and a communication unit 114. The output manager 102 can include an acceleration measurer 104 and a key input sensor 106.

The controller 100 controls general operations of the portable terminal. For example, the controller 100 typically performs processing and control for voice telephony and data communication. In addition to performing general operations, according to the present invention, in a case where the controller 100 senses an input for display switching of the portable terminal, the controller 100 judges whether the sensed input is an input for display switching according to a user's intention. That is, the controller determines whether or not the sensed input is intentional or unintentional after judging if the sensed input is an input for display switching, the controller 100 performs a process of increasing a judgment rate on the input before performing the display switching, to prevent display switching in circumstances not intended by a user.

The output manager 102 senses an input for switching a display being output in the portable terminal under the instruction of the controller 100, and the output manager 102 communicates with the controller to determine if the sensed input is an intentional input generated by the user intending to switch the display.

That is, the output manager 102 processes the acceleration measurer 104 to determine a motion of the portable terminal, and processes the key input sensor 106 to sense a key input made by a user of the portable terminal.

The output manager 102 then judges if the terminal motion and key input are an input intended by a user for implementing a function such as display switching (i.e., an input for display switching), according to a time at which the terminal motion and key input are generated.

The memory unit 108 of the portable terminal preferably includes, for example, a Read Only Memory (ROM), a Random Access Memory (RAM), a flash ROM, and the like. The ROM preferably stores a microcode (i.e., code) of a program for processing and controlling the controller 100 and the output manager 102 and a variety of kinds of reference data.

The RAM provides a working memory of the controller 100, and stores temporary data generated in execution of a variety of kinds of programs. The flash ROM stores a diversity of kinds of updateable depository data such as a phone book, an outgoing message, an incoming message, information of a user touch input point, and the like.

The input unit 110 typically includes a plurality of keys that may include numeral key buttons ‘0’ to ‘9’, a menu button, a cancel button, an OK button, a talk button, an end button, an Internet button, navigation key (or direction key) buttons, a plurality of function keys such as a character input key, and the like. The input unit 110 provides the controller 100 with key input data (e.g., a display switching request) corresponding to a key pressed by a user. A person of ordinary skill in the art understands and appreciates that the input unit is not limited to physical key buttons and may include touch screens or pads, etc.

The display unit 112 displays state information generated during operation of the portable terminal, a limited number of characters, a large amount of moving pictures, still pictures, and the like. The display unit 112 may comprise a color Liquid Crystal Display (LCD), Active Mode Organic Light Emitting Diode (AMOLED), or any type of thin-film display technology and the like. The display unit 112 may include a touch input device and, in case of applying to a portable terminal of a touch input scheme, can be used as an input device.

The communication unit 114 transmits/receives and processes a radio signal of data, which is input/output through an antenna (not shown). For example, in a transmission mode, the communication unit 114 may process original data through channel coding and spreading, converting the original data into a Radio Frequency (RF) signal, and transmitting the RF signal. In a reception mode, the communication unit 114 converts a received RF signal into a baseband signal, processes the baseband signal through de-spreading and channel decoding, and restores the signal to original data. Of course, an artisan should understand and appreciate that the claimed invention is not limited to a spread spectrum protocol.

A function of the output manager 102 can be implemented by the controller 100 of the portable terminal. However, while the drawings and description provide for separately construction, it should be understood by those skilled in the art that various modifications of construction can be made within the scope of the presently claimed invention. For example, construction can also be such that some or all of the items shown in FIG. 1 are integrated in a single unit and, for example, the output manager function could be processed in the controller 100.

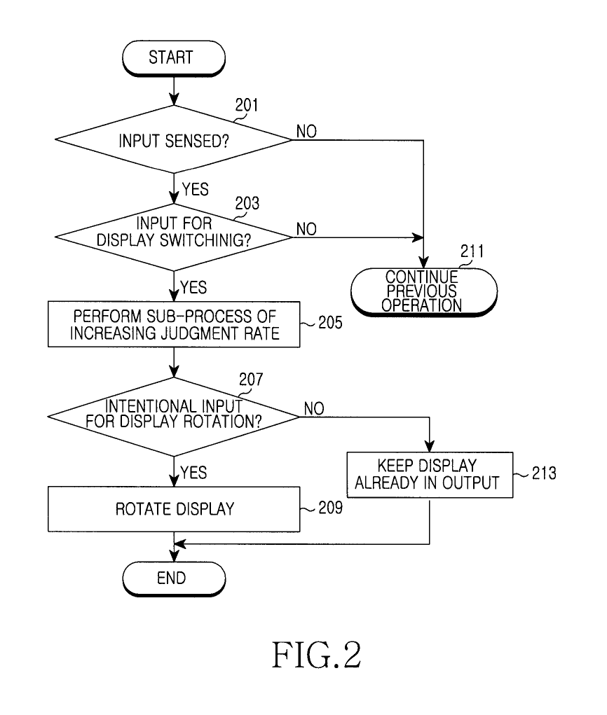

FIG. 2 is a flowchart illustrating a process of display rotation of a portable terminal according to the present invention.

Referring now to FIG. 2, in step 201, the portable terminal determines whether or not the portable terminal senses a user's input.

In case of not sensing the user's input in step 201, the portable terminal proceeds to step 211 and continues a previous operation (e.g. continues performing an unrelated function, such as remaining in an idle mode).

On the other hand, in case of sensing the user's input in step 201, the portable terminal proceeds to step 203 and judges whether or not the sensed input is an input for display switching. Here, the process of judging if the sensed input is the input for display switching is a process of judging whether the sensed input is a key input for switching the display direction of the portable terminal. In case of sensing a tilt of the portable terminal in step 201, when the sensed tilt is equal to or more than a constant tilt, the portable terminal may judge the sensed tilt to be an input for display switching.

In case that judging the sensed input not to be the input for display switching in step 203, the portable terminal proceeds to step 211 and continues performing a previous operation (e.g., maintaining an operation already in execution).

On the other hand, in case that judging the sensed input to be the input for display switching in step 203, the portable terminal proceeds to step 205 and performs a sub-process of increasing a judgment rate on the input for display switching judged in step 203. Step 205 is a sub-process of preventing a phenomenon of switching a display of the portable terminal due to the occurrence of a user's unintentional terminal input (e.g., tilting motion) in an existing portable terminal. At this time, the sub-process of increasing the judgment rate can be conducted by determining a key input generated within a predetermined time and a rotational acceleration of the terminal generated within a predetermined time. Due to this sub-process at step 205, the display switching caused by the occurrence of an unintentional terminal input can be prevented.

For example, in case that the portable terminal senses that a key input has been continuously generated within a predetermined time, the portable terminal determines that the sensed input is not an input that a user has performed with the intention of display switching, and thus does not switch a display of the portable terminal or switches the display, not during a predetermined period of time, but after the lapse of the predetermined period of time.

At this time, the portable terminal can perform a process of increasing a judgment rate on an input for display switching regarding, for example, a continuous or discontinuous key input. In another exemplary embodiment, in case that a portable terminal measures a rotational acceleration of the terminal during a predetermined time and judges the rotational acceleration as not being an intentional input by a user carries with the intention of causing display switching, the portable terminal preferably does not perform the display switching under such circumstances.

After performing the process of increasing the judgment rate in step 205, the portable terminal then at step 207 performs a process of determining if the judgment of step 203 on the input for display rotation is a correct judgment, i.e., whether the sensed input is a user's intentional input for display switching.

In case that determining that the judgment of step 203 is an incorrect judgment according to the process of increasing the judgment rate in step 207, then at step 213 the portable terminal retains the display already being output.

On the other hand, if at step 207 in case it is determined that the judgment of step 203 is a correct judgment according to the process for increasing the judgment rate in step 207, the portable terminal regards the sensed input as an input that a user performed intentionally for display switching and, in step 209, performs the display switching for a display being already in output.

After that, the portable terminal terminates the process according to this particular exemplary embodiment of the present invention.

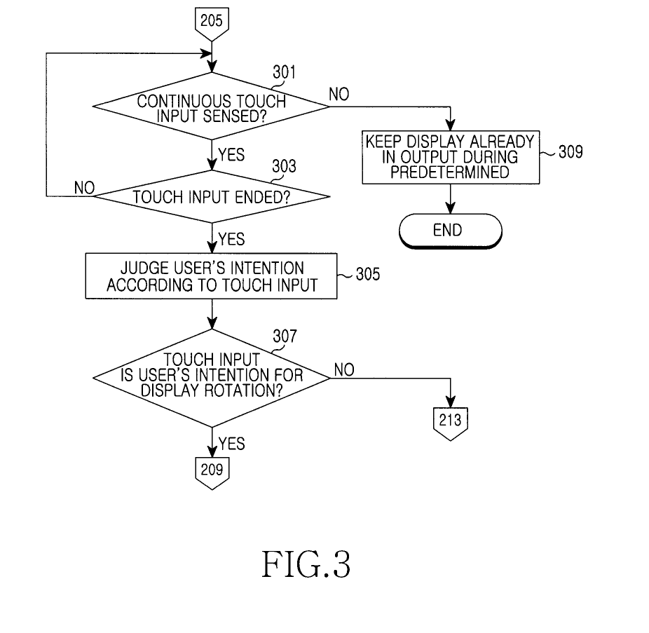

FIG. 3 is a flowchart illustrating a process of display rotation of a portable terminal according to a preferable exemplary embodiment of the present invention.

In FIG. 3, it is assumed that the portable terminal judges a user's input to be an input for display switching and then, performs a process of increasing a judgment rate for the judgment as in step 205 of FIG. 2 described earlier.

When performing the process of increasing the judgment rate as above, the portable terminal proceeds to step 301 and determines whether or not the portable terminal senses a continuous touch input as an input for display switching. Here, the continuous touch input can be, for example, a continuous touch input for display switching and can be an input generated between generation of an input for display switching and performance of the display switching.

In the case where a continuous touch input is not sensed in step 301, the portable terminal proceeds to step 309 and processes to keep a display already in output during a predetermined time. After that, the portable terminal terminates the process according to this exemplary embodiment of the present invention.

On the other hand, in case that the sensing of the continuous touch input is determined in step 301, the portable terminal proceeds to step 303 and determines whether the portable terminal senses a touch input has ended.

In step 303 where it is not sensed that the touch input has ended in step 303, the portable terminal repeatedly performs the process of step 301.

On the other hand, in step 303 in the case where it is sensed that the touch input has ended, the portable terminal proceeds to step 305 and performs a process of judging a user's intention according to a touch input.

At this time, in order to judge the user's intention, the portable terminal can set a judgment rate on a user's intentional input dependent on a time at which a continuous touch input is generated, such as in Table 1 below.

TABLE 1

| Time | Judgment rate | Remark |
|---|---|---|
| Continuous touch sensing | −3 | Very high possibility that a user will |
| between 0.1 to 1 seconds | | perform an operation needing a touch input |
| Continuous touch sensing | −2 | High possibility that a user will perform an |
| between 1 to 2 seconds | | operation needing a touch input |
| Continuous touch sensing | −1 | Low possibility that a user will perform an |
| between 2 to 5 seconds | | operation needing a touch input |
| Continuous touch sensing in | 0 | Very low possibility that a user will |
| excess of 5 seconds | | perform an operation needing a touch input |

For example, based on Table 1, in the case where the portable terminal senses a continuous touch within one second, the portable terminal judges that a user provides an unintentional input for display switching while executing an operation needing a touch input because the short duration makes for a very high possibility that a touch input is desired, and keeps a display already in output as it is without switching.

On the contrary, in case that the portable terminal senses a continuous touch at a time point of the lapse of 5 seconds, the portable terminal can judge that the user provides an intentional input for display switching without executing an operation needing a touch input, and processes a rotation of the display already being output.

After that, the portable terminal proceeds to step 307 and determines whether a user's touch input is an intentional touch input for display rotation through the judgment process of step 305.

In case where it is determined that the touch input is not the user's intentional touch input in step 307, the portable terminal proceeds back to step 213 of FIG. 2 described earlier and keeps a display being already in output as it is.

On the other hand, in case that determining that the touch input is determined to be the user's intentional touch input in step 307, the portable terminal proceeds back to step 209 of FIG. 2 and processes to rotate the display already in output.

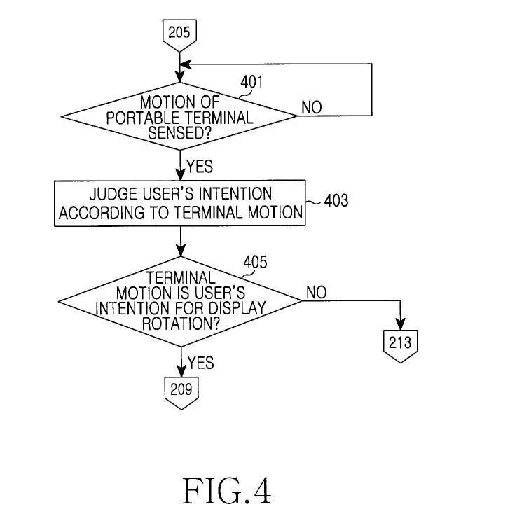

FIG. 4 is a flowchart illustrating a process of display rotation of a portable terminal according to another preferred exemplary embodiment of the present invention.

In FIG. 4, it is assumed that the portable terminal judges a user's input to be an input for display switching and then, performs a process of increasing a judgment rate for the judgment as in step 205 of FIG. 2 described earlier.

When intending to perform the process of increasing the judgment rate as above, at step 401 the portable terminal determines whether or not the portable terminal senses a terminal motion as an input for display switching. Here, step 401 senses the terminal motion as the input for display switching as above or sense a terminal motion generated between generation of a specific input for display switching and performance of the display switching.

In case that it is not determined that there is terminal motion in step 401, the portable terminal repeatedly performs the process of step 401.

On the other hand, in case that the terminal motion is sensed as the input for display switching in step 401, the method proceeds to step 403 and the terminal performs a process of judging a user's intention according to a motion of the portable terminal.

At this time, in order to judge the user's intention, the portable terminal can set a judgment rate on a user's intentional input dependent on a time at which a terminal motion is generated as in Table 2 below.

TABLE 2

| Time | Judgment rate | Remark |
|---|---|---|
| Rotation of 90′ between 0.1 to | +3 | Very high possibility of intentional rotation |
| 1 seconds | | for display switching |
| Rotation of 90′ between 1 to 2 | +2 | High possibility of intentional rotation for |
| seconds | | display switching |
| Rotation of 90′ between 2 to 5 | +1 | Low possibility of intentional rotation for |
| seconds | | display switching |
| Rotation of 90′ in excess of 5 | 0 | Very low possibility of intentional rotation |
| seconds | | for display switching |

For example, in case that there is a sensing of a terminal motion for display switching that is sensed as having a duration within one second, the portable terminal judges that a user intentionally rotates the portable terminal for the purpose of display switching, and processes to rotate a display currently in output.

On the contrary, in case that sensing a terminal motion for display switching at a time point of the lapse of 5 seconds, the portable terminal judges that a user does not provide an intentional input for display switching, but the portable terminal rotates according to peripheral conditions within a bag or pocket, and processes to keep a display already in output as it is without rotating.

After that, the portable terminal proceeds to step 405 and determines if a terminal motion by a user is an intentional touch input for display switching, through the judgment process of step 403.

In case at step 405 where it is determined that the terminal motion is not the user's intentional touch input, the portable terminal proceeds to step 213 of FIG. 2 described earlier and processes to keep a display already in output as it is.

On the other hand, in case at step 405 it is determined that the user's touch input is intentional, the portable terminal proceeds to step 209 of FIG. 2 and processes to rotate a display currently in output.

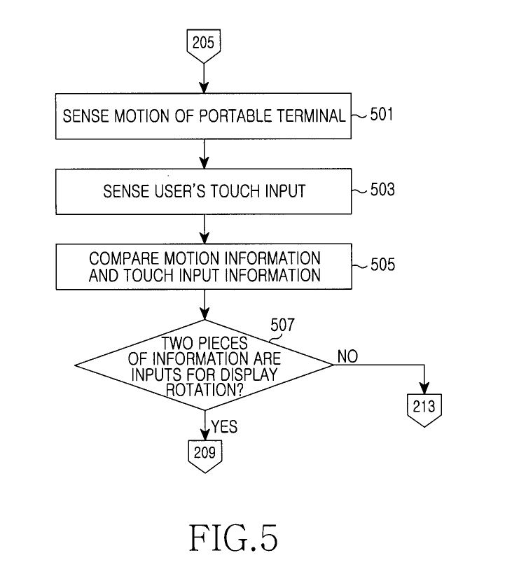

FIG. 5 is a flowchart illustrating an exemplary process of display rotation of a portable terminal according to a still another preferred exemplary embodiment of the present invention.

In FIG. 5, it is assumed that the portable terminal judges a user's input to be an input for display switching and then, performs a process of increasing a judgment rate for the judgment as in step 205 of FIG. 2 described earlier.

When intending to perform the process of increasing the judgment rate as above, at step 501 the portable terminal senses a motion of itself. After that, the portable terminal proceeds to step 503 and senses a user's touch input. The reason why the portable terminal senses the terminal motion and the touch input is to judge a user's intentional input or not by using a time at which the terminal motion and the touch input are both sensed. By a combination of the information, the portable terminal can improve a judgment rate on the user's intentional input.

At this time, the portable terminal judges the user's intentional input or not by a combination of numerical values of judgment rates contained in Table 1 and Table 2. In more detail, the portable terminal adds a value of a judgment rate on a terminal motion and a value of a judgment rate on a touch input, compares the added value with a predetermined value, and judges the user's intentional input or not.

For one example, the portable terminal judges a user's intentional input or not according to a value of adding a judgment rate representing that a possibility of a user's intentional touch input is higher as a negative (−) value goes higher and a judgment rate representing that a possibility of a user's intentional motion is higher as a positive (+) value goes higher. In detail, in case that the sum of a judgment rate (X) representing a possibility of a user's intentional touch input and a judgment rate (Y) representing a possibility of a user's intentional motion is equal to a negative value (X+Y<0), the portable terminal regards the sensed motion and touch input as unintentional inputs of the user and does not to rotate a display image of the portable terminal. In case that the sum of the two judgment rates is equal to a positive value (X+Y>0), the portable terminal judges the sensed motion and touch input as being intentional inputs of the user and rotates a display currently in output.

Next, in step 505, the portable terminal compares motion information and touch input information, then, in step 507, determines if the two pieces of information are inputs for display switching.

In case that judging that the information are not the inputs for display switching in step 507, the method proceeds back to step 213 of FIG. 2 and keeps a display already in output (no rotation).

On the other hand, in a case at step 507 in which it is determined that the information are the inputs for display switching, the portable terminal proceeds back to step 209 of FIG. 2 and processes to rotate the display already in output.

Also, the portable terminal may determine where to display switch or not to display switch (i.e. non-switching) according to a rotational angular speed. In case that a user increases an angular speed, i.e., rotates the portable terminal at an angular speed higher than a set angular speed for the sake of display switching, the portable terminal judges that he/she intends for display switching, and performs the display switching. In case that the user rotates the portable terminal at an angular speed lower than the set angular speed value, the portable terminal judges that he/she does not intend for display switching, and accordingly does not perform the display switching.

As described above, exemplary embodiments of the present invention are to, upon receiving an input for display switching intended by a user, switch a display of a portable terminal in order to increase the accuracy of an input for switching the display direction of the portable terminal from length direction to width direction or from the width direction to the length direction according to need. By doing so, the exemplary embodiments of the present invention sense an input for display switching and then perform a process of increasing a judgment rate on the input, thus being capable of switching a display only at the time of receiving a display switching request intended by a user without switching the display in response to a display switching request not intended by the user.

The above-described methods according to the present invention can be realized in hardware or as software or computer code that can be stored in a recording medium such as a CD ROM, an RAM, a floppy disk, a hard disk, or a magneto-optical disk or downloaded over a network for storage on a medium such as one of the aforementioned, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein. While the invention has been shown and described with reference to certain preferred exemplary embodiments thereof, it will be understood by those skilled in the art that various changes in form and details may be made therein without departing from the spirit and scope of the invention as defined by the appended claims.

What is claimed is:

1. An apparatus for display switching in a portable terminal, the apparatus comprising:
an output manager for sensing an input for performing display switching, and for judging whether or not the sensed input is an intended input by a user; and
a controller for controlling to retain a particular direction of a display when the output manager judges that the input for display switching is not an intended input by the user, and for switching the direction of the display and outputting the switched display when the output manager judges that the input for display switching is an intended input by the user.

2. The apparatus of claim 1, wherein the output manager judges whether the sensed input is the intended input by the user by sensing at least one of a continuous key input and a terminal motion.

3. The apparatus of claim 2, wherein the output manager senses the continuous key input prior to performing the display switching and, when determining that a sensed time of the continuous key input is shorter than a reference time set for display switching, the output manager judges that the sensed continuous key input for display switching is not the intended input by the user and, when the output manager determines that the sensed time of the continuous key input is longer than the reference time set for display switching, the output manager judges that the sensed continuous key input for display switching is the intended input by the user.

4. The apparatus of claim 2, wherein the output manager senses the terminal motion prior to performing the display switching and, when determining that a sensed time of the terminal motion is shorter than a reference time set for display switching, the output manager judges that the input for display switching is not the intended input by the user and, when determining that the sensed time of the terminal motion is longer than the reference time set for display switching, the output manager judges that the input for display switching is the intended input by the user.

5. The apparatus of claim 2, wherein the output manager senses the terminal motion prior to performing the display switching and determines an angular speed of the terminal motion and, when the determined angular speed is slower than an angular speed set for display switching, the output manager judges that the input for display switching is not the intended input by the user and, when the determined angular speed is faster than the angular speed set for display switching, the output manager judges that the input for display switching is the intended input by the user and executes display switching.

6. The apparatus of claim 2, wherein, prior to performing the display switching, the output manager determines a sensed time of the terminal motion and a sensed time of the continuous key input, compares the sensed time of the continuous key input and the sensed time of the terminal motion to judge whether or not a user's input is an intentional input for display switching.

7. The apparatus of claim 1, wherein, when sensing an input for a control of the portable terminal prior to performing the display switching, the controller switches a display after a lapse of a predetermined period of time measured from a time point at which the input is sensed.

8. The apparatus of claim 1, wherein, after sensing the input for display switching, the output manager assigns weights to a plurality of elements for display switching, combines the elements having the assigned weights, and judges whether the user intends to display switch or not dependent on a resultant score of the assigned weights.

9. The apparatus of claim 8, wherein the plurality of elements for display switching comprises two or more of a time sensed until a key is input, a time sensed of a motion of the terminal after sensing an input for display switching, and an angular speed of the terminal.

10. A method for display switching in a portable terminal, the method comprising:
(a) sensing an input for display switching;
(b) judging if a sensed input is an intended input by a user;
(c) retaining a direction of a display when it is judged in (b) that the input for display switching is not the intended input; and
(d) switching a display direction when it is judged in (b) that the input for display switching is the intended input by the user, and outputting the switched display.

11. The method of claim 10, wherein when judging in (b) that the sensed input is the intended input is performed by sensing at least one of a continuous key input and a terminal motion.

12. The method of claim 11, wherein judging in (b) that the sensed input is the intended input by the user further comprises:
determining a sensed time of the continuous key input prior to performing the display switching;
determining that the input for display switching is the intended input by the user when the sensed time of the continuous key input is shorter than a reference time set for display switching; and
judging that the input for display switching is the intended input by the user when the sensed time is longer than the reference time set for display switching.

13. The method of claim 11, wherein judging if the sensed input is the intended input by the user further comprises:
determining a sensed time of the terminal motion prior to performing the display switching;
judging that the input for display switching is not the intended input by the user in case that the sensed time of the terminal motion is shorter than a reference time set for display switching; and
judging that the input for display switching is the intended input by the user when the sensed time is longer than the reference time set for display switching.

14. The method of claim 11, wherein judging if the sensed input is the intended input intended by the user further comprises:
sensing the terminal motion prior to performing the display switching;
determining an angular speed for the terminal motion;
judging that the input for display switching is not the intended input by the user and, when the judged angular speed is slower than an angular speed set for display switching; and
judging that the input for display switching is the intended input by the user and executing display switching when the judged angular speed is faster than the angular speed set for display switching.

15. The method of claim 11, wherein judging if the sensed input is the intended input by the user comprises:
determining a sensed time of the terminal motion and a sensed time of the continuous key input prior to performing the display switching; and
comparing the sensed time of the continuous key input and the sensed time of the terminal motion, and judging whether a user's input is an intended input or not.

16. The method of claim 10, further comprising: switching a display after a lapse of a predetermined period of time from a time point in which the input is sensed when sensing an input for a control of the portable terminal prior to performing the display switching.

17. The method of claim 10, further comprising:
assigning weights to a plurality of elements for display switching after sensing the input for display switching; and
combining the elements having the assigned weights, and determining a user's intention to display switch or not dependent on a score of the weighted elements.

18. The method of claim 17, wherein the plurality of elements for display switching comprise two or more of: a time until a key input is sensed, a time that a terminal motion is sensed after sensing an input for display switching, and an angular speed of the terminal.
